(19) United States
(12) Patent Application Publication
(10) Pub. No.: US 2023/0066635 A1
(43) Pub. Date: Mar. 2, 2023

(54) CONTROLLING VEHICLE PERFORMANCE BASED ON DATA ASSOCIATED WITH AN ATMOSPHERIC CONDITION

(71) Applicant: MOTIONAL AD LLC, Boston, MA (US)

(72) Inventor: Jayapradeep Chandrasekaran, Pittsburgh, PA (US)

(21) Appl. No.: 17/412,949

(22) Filed: Aug. 26, 2021

(51) Int. Cl. B60W 30/14; G01C 21/36; B60W 40/10; B60W 40/02; B60W 60/00

(52) U.S. Cl. CPC B60W 30/146; G01C 21/3691; B60W 40/10; B60W 40/02; B60W 60/001; B60W 2555/60; B60W 2555/20

(57) ABSTRACT

Provided are methods for controlling vehicle performance based on data associated with an environmental condition.

### BACKGROUND

Autonomous vehicles (AVs) can be used to transport people and/or cargo (e.g., packages, objects, or other items) from one location to another. For example, an AV can navigate to the location of a person, wait for the person to board the autonomous vehicle, and navigate to a specified destination (e.g., a location selected by the person) without a driver or command inputs from the passenger.

### BRIEF DESCRIPTION OF THE FIGURES

FIG. 1 is an example environment in which a vehicle including one or more components of an autonomous system can be implemented;

FIG. 2 is a diagram of one or more systems of a vehicle including an autonomous system;

FIG. 3 is a diagram of components of one or more devices and/or one or more systems of FIGS. 1 and 2;

FIG. 4 is a diagram of certain components of an autonomous system;

FIGS. 5A-5D are diagrams of a process for controlling vehicle performance using data associated with an atmospheric condition;

FIGS. 6A-6B are schematic diagrams illustrating a vehicle experiencing laminar and turbulent flow, respectively;

FIGS. 7A-7B are schematic diagrams illustrating example vehicle performance parameter calculations based on wind speed and direction information;

FIG. 8 is process flow diagram for controlling vehicle performance using data associated with an atmospheric condition.

### DETAILED DESCRIPTION

In the following description numerous specific details are set forth in order to provide a thorough understanding of the present disclosure for the purposes of explanation. It will be apparent, however, that the embodiments described by the present disclosure can be practiced without these specific details. In some instances, well-known structures and devices are illustrated in block diagram form in order to avoid unnecessarily obscuring aspects of the present disclosure.

Specific arrangements or orderings of schematic elements, such as those representing systems, devices, components, instruction blocks, data elements, and/or the like are illustrated in the drawings for ease of description. However, it will be understood by those skilled in the art that the specific ordering or arrangement of the schematic elements in the drawings is not meant to imply that a particular order or sequence of processing, or separation of processes, is required unless explicitly described as such. Further, the inclusion of a schematic element in a drawing is not meant to imply that such element is required in all embodiments or that the features represented by such element may not be included in or combined with other elements in some embodiments unless explicitly described as such.

Further, where connecting elements such as solid or dashed lines or arrows are used in the drawings to illustrate a connection, relationship, or association between or among two or more other schematic elements, the absence of any such connecting elements is not meant to imply that no connection, relationship, or association can exist. In other words, some connections, relationships, or associations between elements are not illustrated in the drawings so as not to obscure the disclosure. In addition, for ease of illustration, a single connecting element can be used to represent multiple connections, relationships or associations between elements. For example, where a connecting element represents communication of signals, data, or instructions (e.g., “software instructions”), it should be understood by those skilled in the art that such element can represent one or multiple signal paths (e.g., a bus), as may be needed, to affect the communication.

Although the terms first, second, third, and/or the like are used to describe various elements, these elements should not be limited by these terms. The terms first, second, third, and/or the like are used only to distinguish one element from another. For example, a first contact could be termed a second contact and, similarly, a second contact could be termed a first contact without departing from the scope of the described embodiments. The first contact and the second contact are both contacts, but they are not the same contact.

The terminology used in the description of the various described embodiments herein is included for the purpose of describing particular embodiments only and is not intended to be limiting. As used in the description of the various described embodiments and the appended claims, the singular forms “a,” “an” and “the” are intended to include the plural forms as well and can be used interchangeably with “one or more” or “at least one,” unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this description specify the presence of stated features, integers, steps, operations, elements, and/or components, but do not preclude the presence or addition of one or more other features, integers, steps, operations, elements, components, and/or groups thereof.

As used herein, the terms “communication” and “communicate” refer to at least one of the reception, receipt, transmission, transfer, provision, and/or the like of information (or information represented by, for example, data, signals, messages, instructions, commands, and/or the like). For one unit (e.g., a device, a system, a component of a device or system, combinations thereof, and/or the like) to be in communication with another unit means that the one unit is able to directly or indirectly receive information from and/or send (e.g., transmit) information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and transmits the processed information to the second unit. In some embodiments, a message may refer to a network packet (e.g., a data packet and/or the like) that includes data.

As used herein, the term “if” is, optionally, construed to mean “when”, “upon”, “in response to determining,” “in response to detecting,” and/or the like, depending on the context. Similarly, the phrase “if it is determined” or “if [a stated condition or event] is detected” is, optionally, construed to mean “upon determining,” “in response to determining,” “upon detecting [the stated condition or event],” “in response to detecting [the stated condition or event],” and/or the like, depending on the context. Also, as used herein, the terms “has”, “have”, “having”, or the like are intended to be open-ended terms. Further, the phrase “based on” is intended to mean “based at least partially on” unless explicitly stated otherwise.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments can be practiced without these specific details. In other instances, well-known methods, procedures, components, circuits, and networks have not been described in detail so as not to unnecessarily obscure aspects of the embodiments.

Several features are described hereafter that can each be used independently of one another or with any combination of other features. However, any individual feature may not address any of the problems discussed above or might only address one of the problems discussed above. Some of the problems discussed above might not be fully addressed by any of the features described herein. Although headings are provided, information related to a particular heading, but not found in the section having that heading, may also be found elsewhere in this description. Embodiments are described herein according to the following outline:

1. General Overview

2. Hardware Overview

3. Architecture Overview

4. Architecture Process Flows for Controlling a Vehicle using Data Associated with an Atmospheric Condition

5. Example Use Case—Airflow and Direction

6. Using Data Associated with Atmospheric Condition to Control a Vehicle

### 1. General Overview

Performance metrics for control of a vehicle (e.g., an autonomous vehicle) can be determined using data associated with an atmospheric (or, synonymously, environmental) condition. As an example, air density can be included in a computation of drag on the vehicle and an optimized target vehicle velocity can be determined to minimize drag, which in turn will reduce energy consumption. In an embodiment, wind speed and direction can be taken into account when determining vehicle velocity. A vehicle experiencing a tail wind, for example, operates at a target velocity using less energy than if the vehicle were facing a head wind. Data associated with an environmental condition can be factored into controlling the vehicle in real-time and can also be used in route planning. For example, data associated with an environmental condition can be observed by vehicle sensors in real-time to make immediate velocity changes. In an embodiment, data associated with an environmental condition can be obtained from networked sources and used in route and control planning for the vehicle.

In some aspects and/or embodiments, systems, methods, and computer program products described herein include and/or implement determining the motion of an autonomous vehicle (AV), including vehicle velocity and direction/heading, using atmospheric information, such as information that can factor into the drag force on the autonomous vehicle.

By virtue of the implementation of systems, methods, and computer program products described herein, techniques for controlling an autonomous vehicle using data associated with an environmental condition can increase autonomous vehicle efficiency (e.g., fuel efficiency, navigation while moving toward a destination, etc.) and, more specifically, can result in improved performance metrics, such as reduced energy consumption and improved route planning and execution.

Additionally, or alternatively, operation of a vehicle can be controlled such that motion of the vehicle is less affected by atmospheric conditions (e.g., by headwinds, tailwinds, crosswinds, etc.). This can result in more accurate determinations by the AV (e.g., by AV compute 400 and/or similar devices) about the location of the vehicle, the speed of the vehicle, and/or the like.

In an embodiment, a drag measurement sensor can be used by the vehicle to measure the drag force on the vehicle. Drag measurement sensors can also augment other AV sensors, the AV perception system, and other components that are used to control the velocity and acceleration/deceleration of the vehicle.

### 2. Hardware Overview

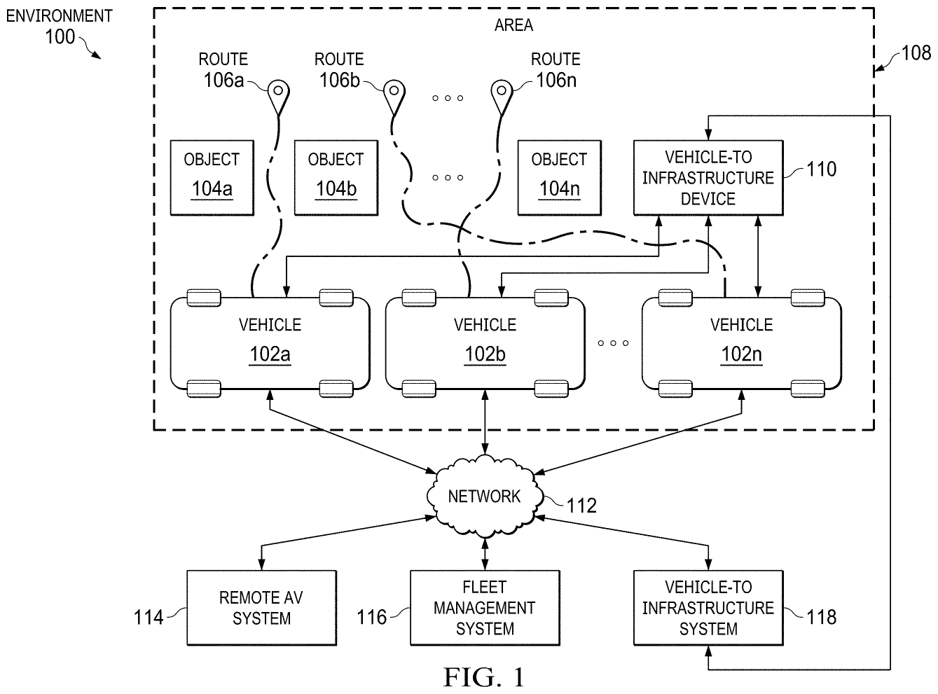

Referring now to FIG. 1, illustrated is example environment 100 in which vehicles that include autonomous systems, as well as vehicles that do not, are operated. As illustrated, environment 100 includes vehicles 102a-102n, objects 104a-104n, routes 106a-106n, area 108, vehicle-to-infrastructure (V2I) device 110, network 112, remote autonomous vehicle (AV) system 114, fleet management system 116, and V2I system 118. Vehicles 102a-102n, vehicle-to-infrastructure (V2I) device 110, network 112, autonomous vehicle (AV) system 114, fleet management system 116, and V2I system 118 interconnect (e.g., establish a connection to communicate and/or the like) via wired connections, wireless connections, or a combination of wired or wireless connections. In some embodiments, objects 104a-104n interconnect with at least one of vehicles 102a-102n, vehicle-to-infrastructure (V2I) device 110, network 112, autonomous vehicle (AV) system 114, fleet management system 116, and V2I system 118 via wired connections, wireless connections, or a combination of wired or wireless connections.

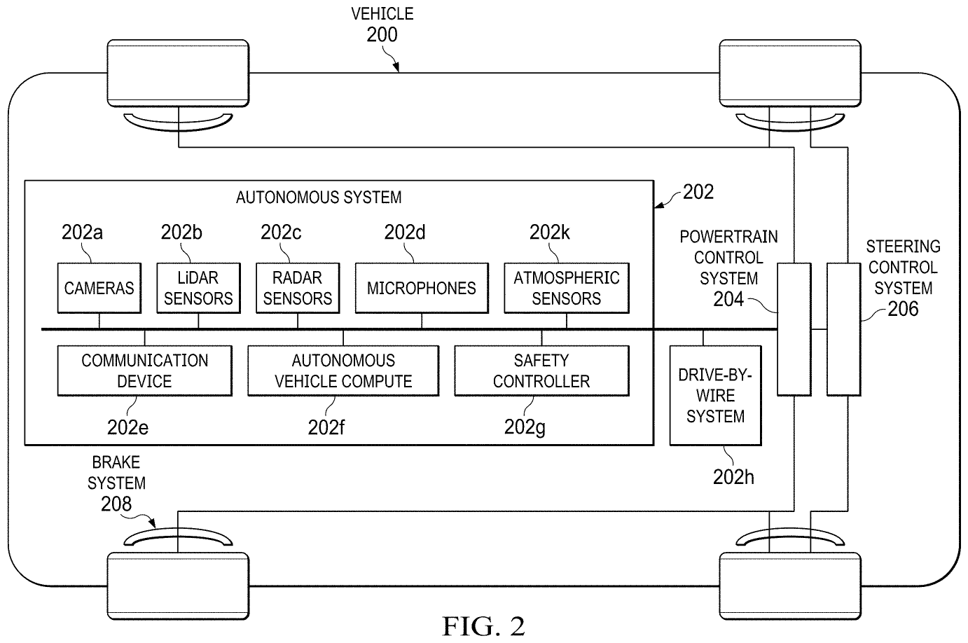

Vehicles 102a-102n (referred to individually as vehicle 102 and collectively as vehicles 102) include at least one device configured to transport goods and/or people. In some embodiments, vehicles 102 are configured to be in communication with V2I device 110, remote AV system 114, fleet management system 116, and/or V2I system 118 via network 112. In some embodiments, vehicles 102 include cars, buses, trucks, trains, and/or the like. In some embodiments, vehicles 102 are the same as, or similar to, vehicles 200, described herein (see FIG. 2). In some embodiments, a vehicle 200 of a set of vehicles 200 is associated with an autonomous fleet manager. In some embodiments, vehicles 102 travel along respective routes 106a-106n (referred to individually as route 106 and collectively as routes 106), as described herein. In some embodiments, one or more vehicles 102 include an autonomous system (e.g., an autonomous system that is the same as or similar to autonomous system 202).

Objects 104a-104n (referred to individually as object 104 and collectively as objects 104) include, for example, at least one vehicle, at least one pedestrian, at least one cyclist, at least one structure (e.g., a building, a sign, a fire hydrant, etc.), and/or the like. Each object 104 is stationary (e.g., located at a fixed location for a period of time) or mobile (e.g., having a velocity and associated with at least one trajectory). In some embodiments, objects 104 are associated with corresponding locations in area 108.

Routes 106a-106n (referred to individually as route 106 and collectively as routes 106) are each associated with (e.g., prescribe) a sequence of actions (also known as a trajectory) connecting states along which an AV can navigate. Each route 106 starts at an initial state (e.g., a state that corresponds to a first spatiotemporal location, velocity, and/or the like) and a final goal state (e.g., a state that corresponds to a second spatiotemporal location that is different from the first spatiotemporal location) or goal region (e.g. a subspace of acceptable states (e.g., terminal states)). In some embodiments, the first state includes a location at which an individual or individuals are to be picked-up by the AV and the second state or region includes a location or locations at which the individual or individuals picked-up by the AV are to be dropped-off. In some embodiments, routes 106 include a plurality of acceptable state sequences (e.g., a plurality of spatiotemporal location sequences), the plurality of state sequences associated with (e.g., defining) a plurality of trajectories. In an example, routes 106 include only high level actions or imprecise state locations, such as a series of connected roads dictating turning directions at roadway intersections. Additionally, or alternatively, routes 106 may include more precise actions or states such as, for example, specific target lanes or precise locations within the lane areas and targeted speed at those positions. In an example, routes 106 include a plurality of precise state sequences along the at least one high level action sequence with a limited lookahead horizon to reach intermediate goals, where the combination of successive iterations of limited horizon state sequences cumulatively correspond to a plurality of trajectories that collectively form the high level route to terminate at the final goal state or region.

Area 108 includes a physical area (e.g., a geographic region) within which vehicles 102 can navigate. In an example, area 108 includes at least one state (e.g., a country, a province, an individual state of a plurality of states included in a country, etc.), at least one portion of a state, at least one city, at least one portion of a city, etc. In some embodiments, area 108 includes at least one named thoroughfare (referred to herein as a “road”) such as a highway, an interstate highway, a parkway, a city street, etc. Additionally, or alternatively, in some examples area 108 includes at least one unnamed road such as a driveway, a section of a parking lot, a section of a vacant and/or undeveloped lot, a dirt path, etc. In some embodiments, a road includes at least one lane (e.g., a portion of the road that can be traversed by vehicles 102). In an example, a road includes at least one lane associated with (e.g., identified based on) at least one lane marking.

Vehicle-to-Infrastructure (V2I) device 110 (sometimes referred to as a Vehicle-to-Infrastructure (V2X) device) includes at least one device configured to be in communication with vehicles 102 and/or V2I infrastructure system 118. In some embodiments, V2I device 110 is configured to be in communication with vehicles 102, remote AV system 114, fleet management system 116, and/or V2I system 118 via network 112. In some embodiments, V2I device 110 includes a radio frequency identification (RFID) device, signage, cameras (e.g., two-dimensional (2D) and/or three-dimensional (3D) cameras), lane markers, streetlights, parking meters, etc. In some embodiments, V2I device 110 is configured to communicate directly with vehicles 102. Additionally, or alternatively, in some embodiments V2I device 110 is configured to communicate with vehicles 102, remote AV system 114, and/or fleet management system 116 via V2I system 118. In some embodiments, V2I device 110 is configured to communicate with V2I system 118 via network 112.

Network 112 includes one or more wired and/or wireless networks. In an example, network 112 includes a cellular network (e.g., a long term evolution (LTE) network, a third generation (3G) network, a fourth generation (4G) network, a fifth generation (5G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN), a private network, an ad hoc network, an intranet, the Internet, a fiber optic-based network, a cloud computing network, etc., a combination of some or all of these networks, and/or the like.

Remote AV system 114 includes at least one device configured to be in communication with vehicles 102, V2I device 110, network 112, remote AV system 114, fleet management system 116, and/or V2I system 118 via network 112. In an example, remote AV system 114 includes a server, a group of servers, and/or other like devices. In some embodiments, remote AV system 114 is co-located with the fleet management system 116. In some embodiments, remote AV system 114 is involved in the installation of some or all of the components of a vehicle, including an autonomous system, an autonomous vehicle compute, software implemented by an autonomous vehicle compute, and/or the like. In some embodiments, remote AV system 114 maintains (e.g., updates and/or replaces) such components and/or software during the lifetime of the vehicle.

Fleet management system 116 includes at least one device configured to be in communication with vehicles 102, V2I device 110, remote AV system 114, and/or V2I infrastructure system 118. In an example, fleet management system 116 includes a server, a group of servers, and/or other like devices. In some embodiments, fleet management system 116 is associated with a ridesharing company (e.g., an organization that controls operation of multiple vehicles (e.g., vehicles that include autonomous systems and/or vehicles that do not include autonomous systems) and/or the like).

In some embodiments, V2I system 118 includes at least one device configured to be in communication with vehicles 102, V2I device 110, remote AV system 114, and/or fleet management system 116 via network 112. In some examples, V2I system 118 is configured to be in communication with V2I device 110 via a connection different from network 112. In some embodiments, V2I system 118 includes a server, a group of servers, and/or other like devices. In some embodiments, V2I system 118 is associated with a municipality or a private institution (e.g., a private institution that maintains V2I device 110 and/or the like).

The number and arrangement of elements illustrated in FIG. 1 are provided as an example. There can be additional elements, fewer elements, different elements, and/or differently arranged elements, than those illustrated in FIG. 1. Additionally, or alternatively, at least one element of environment 100 can perform one or more functions described as being performed by at least one different element of FIG. 1. Additionally, or alternatively, at least one set of elements of environment 100 can perform one or more functions described as being performed by at least one different set of elements of environment 100.

Referring now to FIG. 2, vehicle 200 includes autonomous system 202, powertrain control system 204, steering control system 206, and brake system 208. In some embodiments, vehicle 200 is the same as or similar to vehicle 102 (see FIG. 1). In some embodiments, vehicle 102 have autonomous capability (e.g., implement at least one function, feature, device, and/or the like that enable vehicle 200 to be partially or fully operated without human intervention including, without limitation, fully autonomous vehicles (e.g., vehicles that forego reliance on human intervention), highly autonomous vehicles (e.g., vehicles that forego reliance on human intervention in certain situations), and/or the like). For a detailed description of fully autonomous vehicles and highly autonomous vehicles, reference may be made to SAE International's standard J3016: Taxonomy and Definitions for Terms Related to On-Road Motor Vehicle Automated Driving Systems, which is incorporated by reference in its entirety. In some embodiments, vehicle 200 is associated with an autonomous fleet manager and/or a ridesharing company.

Autonomous system 202 includes a sensor suite that includes one or more devices such as cameras 202a, LiDAR sensors 202b, radar sensors 202c, and microphones 202d. In some embodiments, autonomous system 202 can include more or fewer devices and/or different devices (e.g., ultrasonic sensors, inertial sensors, GPS receivers (discussed below), odometry sensors that generate data associated with an indication of a distance that vehicle 200 has traveled, and/or the like). In some embodiments, autonomous system 202 uses the one or more devices included in autonomous system 202 to generate data associated with environment 100, described herein. The data generated by the one or more devices of autonomous system 202 can be used by one or more systems described herein to observe the environment (e.g., environment 100) in which vehicle 200 is located. In some embodiments, autonomous system 202 includes communication device 202e, autonomous vehicle compute 202f, and drive-by-wire (DBW) system 202h.

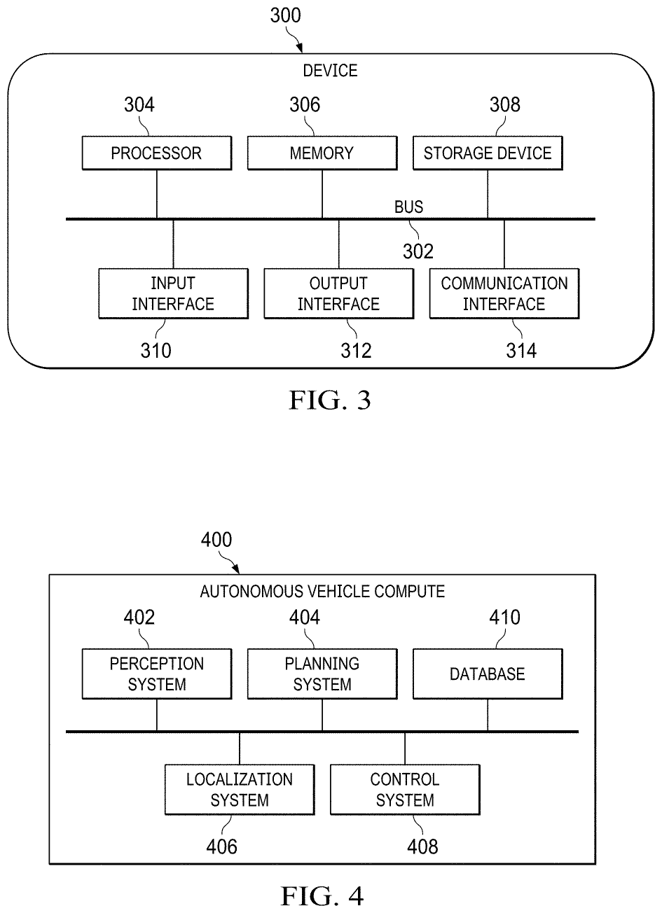

Cameras 202a include at least one device configured to be in communication with communication device 202e, autonomous vehicle compute 202f, and/or safety controller 202g via a bus (e.g., a bus that is the same as or similar to bus 302 of FIG. 3). Cameras 202a include at least one camera (e.g., a digital camera using a light sensor such as a charge-coupled device (CCD), a thermal camera, an infrared (IR) camera, an event camera, and/or the like) to capture images including physical objects (e.g., cars, buses, curbs, people, and/or the like). In some embodiments, camera 202a generates camera data as output. In some examples, camera 202a generates camera data that includes image data associated with an image. In this example, the image data may specify at least one parameter (e.g., image characteristics such as exposure, brightness, etc., an image timestamp, and/or the like) corresponding to the image. In such an example, the image may be in a format (e.g., RAW, JPEG, PNG, and/or the like). In some embodiments, camera 202a includes a plurality of independent cameras configured on (e.g., positioned on) a vehicle to capture images for the purpose of stereopsis (stereo vision). In some examples, camera 202a includes a plurality of cameras that generate image data and transmit the image data to autonomous vehicle compute 202f and/or a fleet management system (e.g., a fleet management system that is the same as or similar to fleet management system 116 of FIG. 1). In such an example, autonomous vehicle compute 202f determines depth to one or more objects in a field of view of at least two cameras of the plurality of cameras based on the image data from the at least two cameras. In some embodiments, cameras 202a is configured to capture images of objects within a distance from cameras 202a (e.g., up to 100 meters, up to a kilometer, and/or the like). Accordingly, cameras 202a include features such as sensors and lenses that are optimized for perceiving objects that are at one or more distances from cameras 202a.

In an embodiment, camera 202a includes at least one camera configured to capture one or more images associated with one or more traffic lights, street signs and/or other physical objects that provide visual navigation information. In some embodiments, camera 202a generates traffic light data associated with one or more images. In some examples, camera 202a generates TLD data associated with one or more images that include a format (e.g., RAW, JPEG, PNG, and/or the like). In some embodiments, camera 202a that generates TLD data differs from other systems described herein incorporating cameras in that camera 202a can include one or more cameras with a wide field of view (e.g., a wide-angle lens, a fish-eye lens, a lens having a viewing angle of approximately 120 degrees or more, and/or the like) to generate images about as many physical objects as possible.

Laser Detection and Ranging (LiDAR) sensors 202b include at least one device configured to be in communication with communication device 202e, autonomous vehicle compute 202f, and/or safety controller 202g via a bus (e.g., a bus that is the same as or similar to bus 302 of FIG. 3). LiDAR sensors 202b include a system configured to transmit light from a light emitter (e.g., a laser transmitter). Light emitted by LiDAR sensors 202b include light (e.g., infrared light and/or the like) that is outside of the visible spectrum. In some embodiments, during operation, light emitted by LiDAR sensors 202b encounters a physical object (e.g., a vehicle) and is reflected back to LiDAR sensors 202b. In some embodiments, the light emitted by LiDAR sensors 202b does not penetrate the physical objects that the light encounters. LiDAR sensors 202b also include at least one light detector which detects the light that was emitted from the light emitter after the light encounters a physical object. In some embodiments, at least one data processing system associated with LiDAR sensors 202b generates an image (e.g., a point cloud, a combined point cloud, and/or the like) representing the objects included in a field of view of LiDAR sensors 202b. In some examples, the at least one data processing system associated with LiDAR sensor 202b generates an image that represents the boundaries of a physical object, the surfaces (e.g., the topology of the surfaces) of the physical object, and/or the like. In such an example, the image is used to determine the boundaries of physical objects in the field of view of LiDAR sensors 202b.

Radio Detection and Ranging (radar) sensors 202c include at least one device configured to be in communication with communication device 202e, autonomous vehicle compute 202f, and/or safety controller 202g via a bus (e.g., a bus that is the same as or similar to bus 302 of FIG. 3). Radar sensors 202c include a system configured to transmit radio waves (either pulsed or continuously). The radio waves transmitted by radar sensors 202c include radio waves that are within a predetermined spectrum In some embodiments, during operation, radio waves transmitted by radar sensors 202c encounter a physical object and are reflected back to radar sensors 202c. In some embodiments, the radio waves transmitted by radar sensors 202c are not reflected by some objects. In some embodiments, at least one data processing system associated with radar sensors 202c generates signals representing the objects included in a field of view of radar sensors 202c. For example, the at least one data processing system associated with radar sensor 202c generates an image that represents the boundaries of a physical object, the surfaces (e.g., the topology of the surfaces) of the physical object, and/or the like. In some examples, the image is used to determine the boundaries of physical objects in the field of view of radar sensors 202c.

Microphones 202d includes at least one device configured to be in communication with communication device 202e, autonomous vehicle compute 202f, and/or safety controller 202g via a bus (e.g., a bus that is the same as or similar to bus 302 of FIG. 3). Microphones 202d include one or more microphones (e.g., array microphones, external microphones, and/or the like) that capture audio signals and generate data associated with (e.g., representing) the audio signals. In some examples, microphones 202d include transducer devices and/or like devices. In some embodiments, one or more systems described herein can receive the data generated by microphones 202d and determine a position of an object relative to vehicle 200 (e.g., a distance and/or the like) based on the audio signals associated with the data.

Communication device 202e include at least one device configured to be in communication with cameras 202a, LiDAR sensors 202b, radar sensors 202c, microphones 202d, autonomous vehicle compute 202f, safety controller 202g, and/or DBW system 202h. For example, communication device 202e may include a device that is the same as or similar to communication interface 314 of FIG. 3. In some embodiments, communication device 202e includes a vehicle-to-vehicle (V2V) communication device (e.g., a device that enables wireless communication of data between vehicles).

Autonomous vehicle compute 202f include at least one device configured to be in communication with cameras 202a, LiDAR sensors 202b, radar sensors 202c, microphones 202d, communication device 202e, safety controller 202g, and/or DBW system 202h. In some examples, autonomous vehicle compute 202f includes a device such as a client device, a mobile device (e.g., a cellular telephone, a tablet, and/or the like) a server (e.g., a computing device including one or more central processing units, graphical processing units, and/or the like), and/or the like. In some embodiments, autonomous vehicle compute 202f is the same as or similar to autonomous vehicle compute 400, described herein. Additionally, or alternatively, in some embodiments autonomous vehicle compute 202f is configured to be in communication with an autonomous vehicle system (e.g., an autonomous vehicle system that is the same as or similar to remote AV system 114 of FIG. 1), a fleet management system (e.g., a fleet management system that is the same as or similar to fleet management system 116 of FIG. 1), a V2I device (e.g., a V2I device that is the same as or similar to V2I device 110 of FIG. 1), and/or a V2I system (e.g., a V2I system that is the same as or similar to V2I system 118 of FIG. 1).

Safety controller 202g includes at least one device configured to be in communication with cameras 202a, LiDAR sensors 202b, radar sensors 202c, microphones 202d, communication device 202e, autonomous vehicle computer 202f, and/or DBW system 202h. In some examples, safety controller 202g includes one or more controllers (electrical controllers, electromechanical controllers, and/or the like) that are configured to generate and/or transmit control signals to operate one or more devices of vehicle 200 (e.g., powertrain control system 204, steering control system 206, brake system 208, and/or the like). In some embodiments, safety controller 202g is configured to generate control signals that take precedence over (e.g., overrides) control signals generated and/or transmitted by autonomous vehicle compute 202f.

DBW system 202h includes at least one device configured to be in communication with communication device 202e and/or autonomous vehicle compute 202f. In some examples, DBW system 202h includes one or more controllers (e.g., electrical controllers, electromechanical controllers, and/or the like) that are configured to generate and/or transmit control signals to operate one or more devices of vehicle 200 (e.g., powertrain control system 204, steering control system 206, brake system 208, and/or the like). Additionally, or alternatively, the one or more controllers of DBW system 202h are configured to generate and/or transmit control signals to operate at least one different device (e.g., a turn signal, headlights, door locks, windshield wipers, and/or the like) of vehicle 200.

The vehicle 200 can include at least one atmospheric sensor 202k. The atmospheric sensor 202k can detect an atmospheric condition and provide information about the atmospheric condition to a component of the AV compute 202f, such as the planning system 404 or the perception system 402, described in reference to FIG. 4. As an example, a laser configured with laser backscattering can be used to detect air temperature and density. In another example, dedicated sensors, such as aerometers, anemometers, rain sensors, or other types of sensors, can be used to detect various types of atmospheric conditions. In one non-limiting example, an anemometer can be used to detect wind speed and direction information for drag calculations. An aerometer can be used to measure air density for drag calculations. Other sensors or sensor combinations can be used to measure various atmospheric conditions. In addition, the atmospheric sensor 202k can be positioned at a single point on the vehicle 200 or at multiple points on the vehicle 200.

Powertrain control system 204 includes at least one device configured to be in communication with DBW system 202h. In some examples, powertrain control system 204 includes at least one controller, actuator, and/or the like. In some embodiments, powertrain control system 204 receives control signals from DBW system 202h and powertrain control system 204 causes vehicle 200 to start moving forward, stop moving forward, start moving backward, stop moving backward, accelerate in a direction, decelerate in a direction, perform a left turn, perform a right turn, and/or the like. In an example, powertrain control system 204 causes the energy (e.g., fuel, electricity, and/or the like) provided to a motor of the vehicle to increase, remain the same, or decrease, thereby causing at least one wheel of vehicle 200 to rotate or not rotate.

Steering control system 206 includes at least one device configured to rotate one or more wheels of vehicle 200. In some examples, steering control system 206 includes at least one controller, actuator, and/or the like. In some embodiments, steering control system 206 causes the front two wheels and/or the rear two wheels of vehicle 200 to rotate to the left or right to cause vehicle 200 to turn to the left or right. (The terms front and rear are used here to indicate relative positions, and not locations of the AV; front and rear could be switched without deviating from the scope of the disclosure.) (It is also understood that powertrain control system 204 and steering control system 206 can be duplicated in implementations that include multiple motors (e.g., for a dual motor electric vehicle)).

Brake system 208 includes at least one device configured to actuate one or more brakes to cause vehicle 200 to reduce speed and/or remain stationary. In some examples, brake system 208 includes at least one controller and/or actuator that is configured to cause one or more calipers associated with one or more wheels of vehicle 200 to close on a corresponding rotor of vehicle 200. Additionally, or alternatively, in some examples brake system 208 includes an automatic emergency braking (AEB) system, a regenerative braking system, and/or the like.

In some embodiments, vehicle 200 includes at least one platform sensor (not explicitly illustrated) that measures or infers properties of a state or a condition of vehicle 200. In some examples, vehicle 200 includes platform sensors such as a global positioning system (GPS) receiver, an inertial measurement unit (IMU), a wheel speed sensor, a wheel brake pressure sensor, a wheel torque sensor, an engine torque sensor, a steering angle sensor, and/or the like.

In some embodiments, the vehicle 200 can include one or more atmospheric sensors 202k. The atmospheric sensors 202k can be positioned at various locations on the vehicle to detect atmospheric phenomena. For example, an atmospheric sensor 202k can measure wind speed, turbulence, wind direction, drag, pressure, and other atmospheric conditions. The atmospheric sensor 202k can provide information to the AV compute for calculating information for controlling the AV. In some embodiments, the atmospheric sensor 202k can perform calculations, such as drag and aerodynamic coefficient calculations. Example sensors include aerometers, thermometers, barometers, etc.

### 3. Architecture Overview

Referring now to FIG. 3, illustrated is a schematic diagram of a device 300. As illustrated, device 300 includes processor 304, memory 306, storage component 308, input interface 310, output interface 312, communication interface 314, and bus 302. In some embodiments, device 300 corresponds to at least one device of vehicles 102 (e.g., at least one device of a system of vehicles 102) and/or one or more devices of network 112 (e.g., one or more devices of a system of network 112). In some embodiments, one or more devices of vehicles 102 (e.g., one or more devices of a system of vehicles 102) and/or one or more devices of network 112 (e.g., one or more devices of a system of network 112) include at least one device 300 and/or at least one component of device 300. As shown in FIG. 3, device 300 includes bus 302, processor 304, memory 306, storage component 308, input interface 310, output interface 312, and communication interface 314.

Bus 302 includes a component that permits communication among the components of device 300. In some embodiments, processor 304 is implemented in hardware, software, or a combination of hardware and software. In some examples, processor 304 includes a processor (e.g., a central processing unit (CPU), a graphics processing unit (GPU), an accelerated processing unit (APU), and/or the like), a microphone, a digital signal processor (DSP), and/or any processing component (e.g., a field-programmable gate array (FPGA), an application specific integrated circuit (ASIC), and/or the like) that can be programmed to perform at least one function. Memory 306 includes random access memory (RAM), read-only memory (ROM), and/or another type of dynamic and/or static storage device (e.g., flash memory, magnetic memory, optical memory, and/or the like) that stores data and/or instructions for use by processor 304.

Storage component 308 stores data and/or software related to the operation and use of device 300. In some examples, storage component 308 includes a hard disk (e.g., a magnetic disk, an optical disk, a magneto-optic disk, a solid state disk, and/or the like), a compact disc (CD), a digital versatile disc (DVD), a floppy disk, a cartridge, a magnetic tape, a CD-ROM, RAM, PROM, EPROM, FLASH-EPROM, NV-RAM, and/or another type of computer readable medium, along with a corresponding drive.

Input interface 310 includes a component that permits device 300 to receive information, such as via user input (e.g., a touchscreen display, a keyboard, a keypad, a mouse, a button, a switch, a microphone, a camera, and/or the like). Additionally or alternatively, in some embodiments input interface 310 includes a sensor that senses information (e.g., a global positioning system (GPS) receiver, an accelerometer, a gyroscope, an actuator, and/or the like). Output interface 312 includes a component that provides output information from device 300 (e.g., a display, a speaker, one or more light-emitting diodes (LEDs), and/or the like).

In some embodiments, communication interface 314 includes a transceiver-like component (e.g., a transceiver, a separate receiver and transmitter, and/or the like) that permits device 300 to communicate with other devices via a wired connection, a wireless connection, or a combination of wired and wireless connections. In some examples, communication interface 314 permits device 300 to receive information from another device and/or provide information to another device. In some examples, communication interface 314 includes an Ethernet interface, an optical interface, a coaxial interface, an infrared interface, a radio frequency (RF) interface, a universal serial bus (USB) interface, a WiFi® interface, a cellular network interface, and/or the like.

In some embodiments, device 300 performs one or more processes described herein. Device 300 performs these processes based on processor 304 executing software instructions stored by a computer-readable medium, such as memory 306 and/or storage component 308. A computer-readable medium (e.g., a non-transitory computer readable medium) is defined herein as a non-transitory memory device. A non-transitory memory device includes memory space located inside a single physical storage device or memory space spread across multiple physical storage devices.

In some embodiments, software instructions are read into memory 306 and/or storage component 308 from another computer-readable medium or from another device via communication interface 314. When executed, software instructions stored in memory 306 and/or storage component 308 cause processor 304 to perform one or more processes described herein. Additionally or alternatively, hardwired circuitry is used in place of or in combination with software instructions to perform one or more processes described herein. Thus, embodiments described herein are not limited to any specific combination of hardware circuitry and software unless explicitly stated otherwise.

Memory 306 and/or storage component 308 includes data storage or at least one data structure (e.g., a database and/or the like). Device 300 is capable of receiving information from, storing information in, communicating information to, or searching information stored in the data storage or the at least one data structure in memory 306 or storage component 308. In some examples, the information includes network data, input data, output data, or any combination thereof.

In some embodiments, device 300 is configured to execute software instructions that are either stored in memory 306 and/or in the memory of another device (e.g., another device that is the same as or similar to device 300). As used herein, the term “component” refers to at least one instruction stored in memory 306 and/or in the memory of another device that, when executed by processor 304 and/or by a processor of another device (e.g., another device that is the same as or similar to device 300) cause device 300 (e.g., at least one component of device 300) to perform one or more processes described herein. In some embodiments, a component is implemented in software, firmware, hardware, and/or the like.

The number and arrangement of components illustrated in FIG. 3 are provided as an example. In some embodiments, device 300 can include additional components, fewer components, different components, or differently arranged components than those illustrated in FIG. 3. Additionally or alternatively, a set of components (e.g., one or more components) of device 300 can perform one or more functions described as being performed by another component or another set of components of device 300.

Referring now to FIG. 4, illustrated is an example block diagram of an autonomous vehicle compute 400 (sometimes referred to as an “AV stack”). As illustrated, autonomous vehicle compute 400 includes perception system 402 (sometimes referred to as a perception component), planning system 404 (sometimes referred to as a planning component), localization system 406 (sometimes referred to as a localization component), control system 408 (sometimes referred to as a control component), and database 410. In some embodiments, perception system 402, planning system 404, localization system 406, control system 408, and database 410 are included and/or implemented in an autonomous navigation system of a vehicle (e.g., within at least one component of an autonomous vehicle compute 202f of vehicle 200). Additionally, or alternatively, in some embodiments perception system 402, planning system 404, localization system 406, control system 408, and database 410 are included in one or more standalone systems (e.g., one or more systems that are the same as or similar to autonomous vehicle compute 400 and/or the like). In some examples, perception system 402, planning system 404, localization system 406, control system 408, and database 410 are included in one or more standalone systems that are located in a vehicle and/or at least one remote system as described herein. In some embodiments, any and/or all of the systems included in autonomous vehicle compute 400 are implemented in software (e.g., in software instructions stored in memory), computer hardware (e.g., by microprocessors, microcontrollers, application-specific integrated circuits (ASICs), Field Programmable Gate Arrays (FPGAs), and/or the like), or combinations of computer software and computer hardware. It will also be understood that, in some embodiments, autonomous vehicle compute 400 is configured to be in communication with a remote system (e.g., an autonomous vehicle system that is the same as or similar to remote AV system 114, a fleet management system 116 that is the same as or similar to fleet management system 116, a V2I system that is the same as or similar to V2I system 118, and/or the like).

In some embodiments, perception system 402 receives data associated with at least one physical object (e.g., data that is used by perception system 402 to detect the at least one physical object) in an environment and classifies the at least one physical object. In some examples, perception system 402 receives image data captured by at least one camera (e.g., cameras 202a), the image associated with (e.g., representing) one or more physical objects within a field of view of the at least one camera. In such an example, perception system 402 classifies at least one physical object based on one or more groupings of physical objects (e.g., bicycles, vehicles, traffic signs, pedestrians, and/or the like). In some embodiments, perception system 402 transmits data associated with the classification of the physical objects to planning system 404 based on perception system 402 classifying the physical objects.

In some embodiments, perception system 402 includes (or receives information from) at least one at atmospheric sensor, which can be used to compute drag on the vehicle, as described in further detail below.

In some embodiments, planning system 404 receives data associated with a destination and generates data associated with at least one route (e.g., routes 106) along which a vehicle (e.g., vehicles 102) can travel along toward a destination. In some embodiments, planning system 404 periodically or continuously receives data from perception system 402 (e.g., data associated with the classification of physical objects, described above) and planning system 404 updates the at least one trajectory or generates at least one different trajectory based on the data generated by perception system 402. In some embodiments, planning system 404 receives data associated with an updated position of a vehicle (e.g., vehicles 102) from localization system 406 and planning system 404 updates the at least one trajectory or generates at least one different trajectory based on the data generated by localization system 406.

In some embodiments, localization system 406 receives data associated with (e.g., representing) a location of a vehicle (e.g., vehicles 102) in an area. In some examples, localization system 406 receives LiDAR data associated with at least one point cloud generated by at least one LiDAR sensor (e.g., LiDAR sensors 202b). In certain examples, localization system 406 receives data associated with at least one point cloud from multiple LiDAR sensors and localization system 406 generates a combined point cloud based on each of the point clouds. In these examples, localization system 406 compares the at least one point cloud or the combined point cloud to two-dimensional (2D) and/or a three-dimensional (3D) map of the area stored in database 410. Localization system 406 then determines the position of the vehicle in the area based on localization system 406 comparing the at least one point cloud or the combined point cloud to the map. In some embodiments, the map includes a combined point cloud of the area generated prior to navigation of the vehicle. In some embodiments, maps include, without limitation, high-precision maps of the roadway geometric properties, maps describing road network connectivity properties, maps describing roadway physical properties (such as traffic speed, traffic volume, the number of vehicular and cyclist traffic lanes, lane width, lane traffic directions, or lane marker types and locations, or combinations thereof), and maps describing the spatial locations of road features such as crosswalks, traffic signs or other travel signals of various types. In some embodiments, the map is generated in real-time based on the data received by the perception system.

In another example, localization system 406 receives Global Navigation Satellite System (GNSS) data generated by a global positioning system (GPS) receiver. In some examples, localization system 406 receives GNSS data associated with the location of the vehicle in the area and localization system 406 determines a latitude and longitude of the vehicle in the area. In such an example, localization system 406 determines the position of the vehicle in the area based on the latitude and longitude of the vehicle. In some embodiments, localization system 406 generates data associated with the position of the vehicle. In some examples, localization system 406 generates data associated with the position of the vehicle based on localization system 406 determining the position of the vehicle. In such an example, the data associated with the position of the vehicle includes data associated with one or more semantic properties corresponding to the position of the vehicle.

In some embodiments, control system 408 receives data associated with at least one trajectory from planning system 404 and control system 408 controls operation of the vehicle. In some examples, control system 408 receives data associated with at least one trajectory from planning system 404 and control system 408 controls operation of the vehicle by generating and transmitting control signals to cause a powertrain control system (e.g., DBW system 202h, powertrain control system 204, and/or the like), a steering control system (e.g., steering control system 206), and/or a brake system (e.g., brake system 208) to operate. In an example, where a trajectory includes a left turn, control system 408 transmits a control signal to cause steering control system 206 to adjust a steering angle of vehicle 200, thereby causing vehicle 200 to turn left. Additionally, or alternatively, control system 408 generates and transmits control signals to cause other devices (e.g., headlights, turn signal, door locks, windshield wipers, and/or the like) of vehicle 200 to change states.

In some embodiments, perception system 402, planning system 404, localization system 406, and/or control system 408 implement at least one machine learning model (e.g., at least one multilayer perceptron (MLP), at least one convolutional neural network (CNN), at least one recurrent neural network (RNN), at least one autoencoder, at least one transformer, and/or the like). In some examples, perception system 402, planning system 404, localization system 406, and/or control system 408 implement at least one machine learning model alone or in combination with one or more of the above-noted systems. In some examples, perception system 402, planning system 404, localization system 406, and/or control system 408 implement at least one machine learning model as part of a pipeline (e.g., a pipeline for identifying one or more objects located in an environment and/or the like). An example of an implementation of a machine learning model is included below with respect to FIGS. 4B-4D.

Database 410 stores data that is transmitted to, received from, and/or updated by perception system 402, planning system 404, localization system 406 and/or control system 408. In some examples, database 410 includes a storage component (e.g., a storage component that is the same as or similar to storage component 308 of FIG. 3) that stores data and/or software related to the operation and uses at least one system of autonomous vehicle compute 400. In some embodiments, database 410 stores data associated with 2D and/or 3D maps of at least one area. In some examples, database 410 stores data associated with 2D and/or 3D maps of a portion of a city, multiple portions of multiple cities, multiple cities, a county, a state, a State (e.g., a country), and/or the like). In such an example, a vehicle (e.g., a vehicle that is the same as or similar to vehicles 102 and/or vehicle 200) can drive along one or more drivable regions (e.g., single-lane roads, multi-lane roads, highways, back roads, off road trails, and/or the like) and cause at least one LiDAR sensor (e.g., a LiDAR sensor that is the same as or similar to LiDAR sensors 202b) to generate data associated with an image representing the objects included in a field of view of the at least one LiDAR sensor.

In some embodiments, database 410 can be implemented across a plurality of devices. In some examples, database 410 is included in a vehicle (e.g., a vehicle that is the same as or similar to vehicles 102 and/or vehicle 200), an autonomous vehicle system (e.g., an autonomous vehicle system that is the same as or similar to remote AV system 114, a fleet management system (e.g., a fleet management system that is the same as or similar to fleet management system 116 of FIG. 1, a V2I system (e.g., a V2I system that is the same as or similar to V2I system 118 of FIG. 1) and/or the like.

In some embodiments, database 410 can store various metrics that can be used to control the vehicle speed, acceleration, braking, steering, and other functions. Among the various metrics are data associated with an environmental condition. Data associated with an environmental condition can be received from various sources, such as on-board sensors, weather centers, Internet sources, user devices (e.g., weather apps on a smartphone), or other places. The data associated with an environmental condition can include temperature, wind speed, wind direction, barometric pressure, humidity, air density, air turbulence, precipitation levels, and other data associated with an environmental condition. These data can be used in, for example, calculating target vehicle velocities to optimize vehicle performance.

The database 410 can also store predicted data associated with an environmental condition at locations along planned routes. Routes can be selected using the data associated with an environmental condition that optimizes AV efficiency. For example, a route that minimizes headwinds is favorable over an alternative route that has higher levels of headwinds because less headwinds reduces energy consumption.

In some embodiments, database 410 stores vehicle control information that was determined remotely based on data associated with an environmental condition local and/or remote to the AV. For example, data associated with an environmental condition can be used by a server to determine optimal speeds at various points in a planned route for an AV. The route itself can also be determined based on data associated with an environmental condition. The planned route as well as the control information can be stored in the database.

The information in the database can be updated periodically as the vehicle traverses a route. For example, atmospheric predictions can be updated using observed data associated with an environmental condition using on-board sensors and/or real-time weather/atmospheric information.

### 4. Data Input and Architecture Process Flows for Controlling a Vehicle Using Data Associated with an Atmospheric Condition

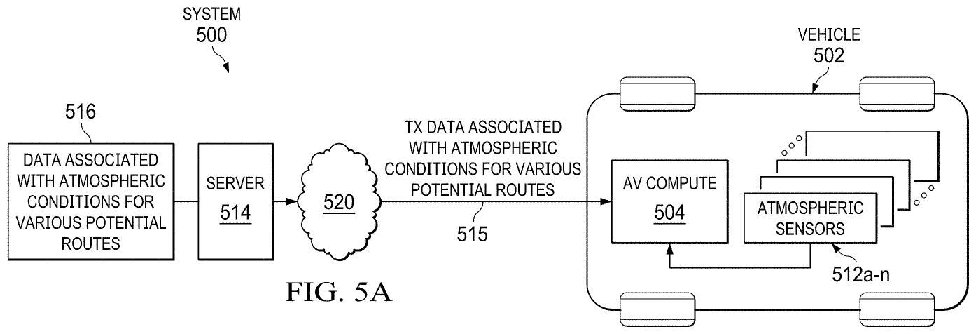

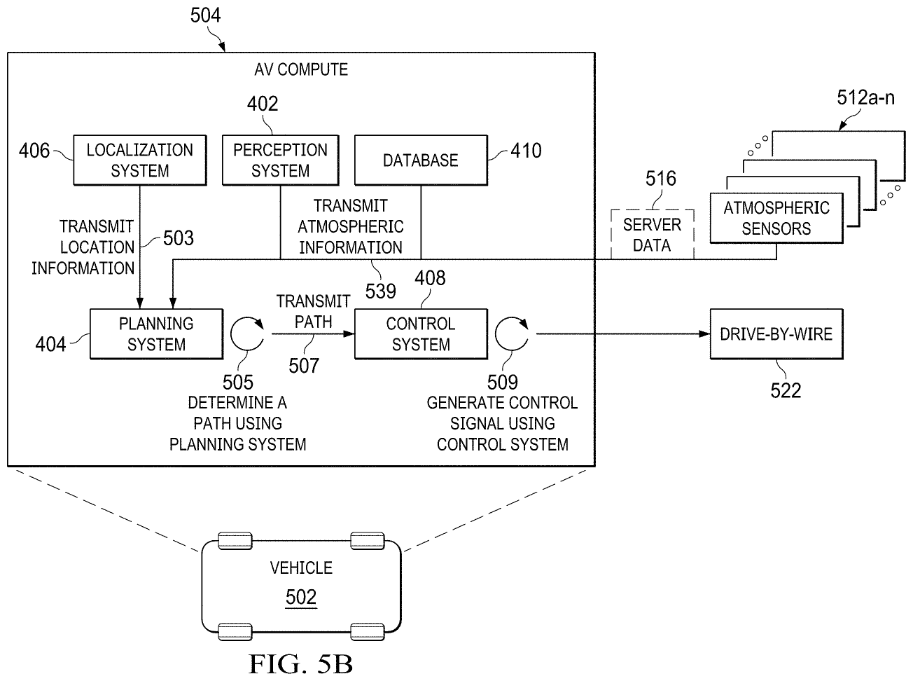

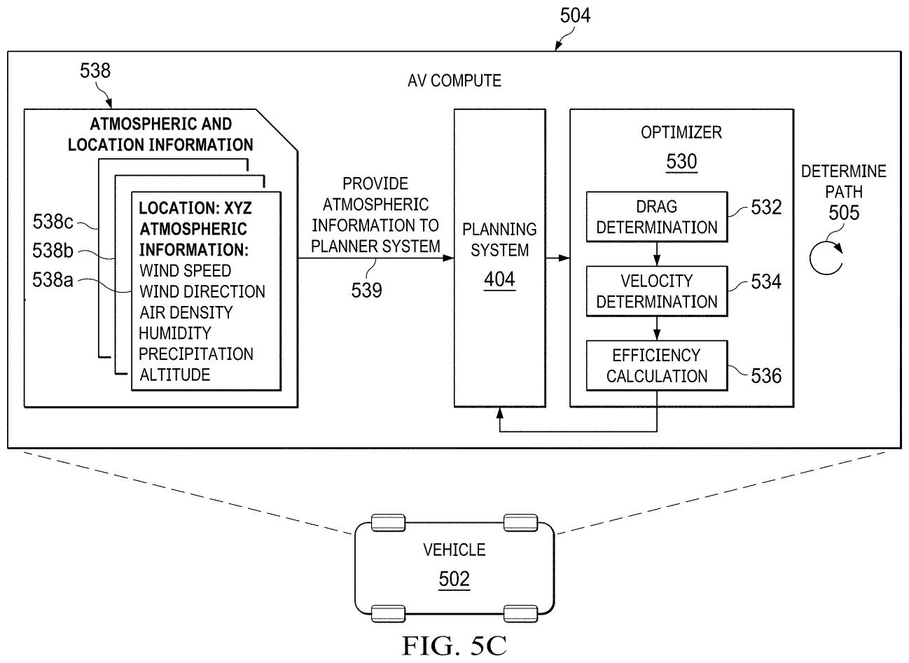

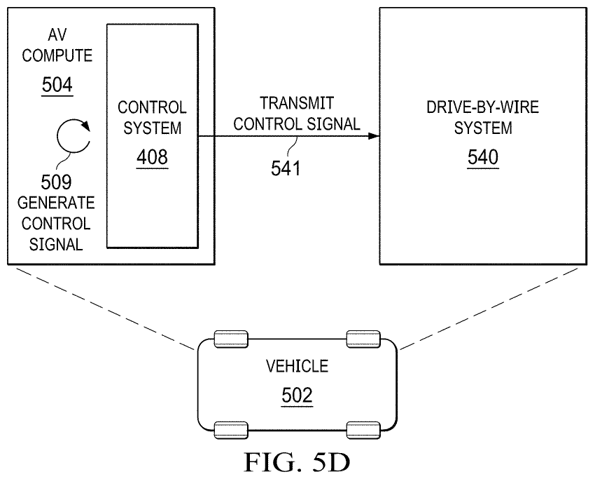

FIGS. 5A-5D are diagrams of a process for controlling vehicle performance using data associated with an atmospheric condition. Turning to FIG. 5A, in an embodiment, system 500 includes a vehicle 502 that includes an AV compute 504 (similar to AV compute 202f and/or AV compute 400). In an embodiment, the vehicle 502 can include one or more atmospheric sensors 512a-n, where n>1, similar to atmospheric sensors 202k, described previously. Atmospheric sensors 512a-n can include at least one of hot wire anemometers, aerometers, wind speed sensors, thermometers, barometers, lidar systems, drag sensors, or other types of sensors that can detect atmospheric condition information. The atmospheric sensors 512a-n can provide data associated with an environmental condition to the AV compute 504. The data associated with the environmental condition can represent at least one of wind speed, wind direction, air density, laminar versus turbulent flow, precipitation, barometric pressure, humidity, The AV compute 504 can use the data associated with an environmental condition in the formulation of vehicle performance metrics (e.g., target velocities), path calculation, and vehicle control. Sensor can be placed at the front and rear of the vehicle to determine the head/tail wind. For example, an atmospheric sensor can be placed inside the hood or bonnet of the vehicle, and a hole can be created in the hood or bonnet to allow air intake so that a surface area (e.g., aerodynamics) of the vehicle stays the same as provided by the original equipment manufacturer (OEM).

In an embodiment, the vehicle 502 can receive data associated with an environmental condition from a remote server 514 over network 520. The server 514 can include components that are the same as, or similar to, the components of device 300 (see FIG. 3). Server 514 can store data 516 associated with atmospheric conditions at various locations. For example, server 514 can store weather information, wind speed, wind direction, humidity information, altitude, air density, precipitation, and other data associated with an environmental condition for a particular location (e.g., a set of geographic coordinates, a road, a town, a city, and/or the like). The data 516 can be specific to certain geographic areas, such as those planned or predicted to be traversed by the vehicle. The data 516 can be received by the server from various sources, such as national or local weather services, other vehicles with on-board sensors through V2V communications, satellites, Internet sources, or other sources.

The data 516 can be transmitted 515 to the vehicle 502 over a network 520. Network 520 can be a cellular network, Wi-Fi network, satellite-based network, or other type of wireless communications network. The data 516 can be stored in the AV compute 504, such as in database 410. The AV compute 504 can use the atmospheric condition information in the formulation of vehicle performance metrics, path calculation, and vehicle control.

FIG. 5B is a schematic diagram illustrating a vehicle 502 with an AV compute 504. AV compute 504 includes a perception system 402, planning system 404, localization system 406, and control system 408, as described previously in reference to FIG. 4. AV compute 504 also includes a database 410 that stores atmospheric condition data, and other data, for determining vehicle performance metrics, vehicle path, and control information. The database 410 can store data associated with an environmental condition received from a remote location or from atmospheric sensors 512a-n. In an embodiment, perception system 402 can also provide data associated with an environmental condition to the database 410.

The perception system 402, database 410, and/or atmospheric sensors 512a-n can send data associated with an environmental condition 539 to the planning system 404. The localization system 406 can provide location information 503 to the planning system 404. The planning system 404 uses data associated with an environmental condition 539, along with other data, to determine vehicle performance metrics. For example, for a given starting point and ending point, the planning system 404 can use the data associated with an environmental condition to calculate a target velocity of the vehicle and a path 505 that optimizes vehicle efficiency (e.g., minimizes energy consumption). The planning system 404 can also use location information 503 to determine weather and other data associated with an environmental condition for the path of the vehicle.

The planning system 404 can calculate a velocity for the vehicle using the data associated with an environmental condition as part of the determination of path 505. The path 505 is transmitted 507 to the control system 408. Control system 408 can generate control signals 509 to execute the path 505. The control signals can be transmitted to the drive-by-wire system 522, which uses the control signals in a closed feedback control system to maneuver the vehicle using at least one of acceleration/deceleration, braking or steering.

In embodiments, changes in atmospheric conditions can trigger alterations of the vehicle performance metrics in real time. For example, increased drag on the vehicle can cause the velocity to change or the path 505 to be altered to reduce drag to maintain energy efficiency or to reach the destination given the amount of vehicle power remaining.

FIG. 5C is a schematic diagram illustrating a planning system that use data associated with an environmental condition to determine vehicle performance metrics in accordance with embodiments of the present disclosure. The planning system 404 includes an optimization component 530. Optimization component 530 includes drag determination component 532 and velocity determination component 534.

Drag determination component 530 can include hardware components, software components, or a combination of hardware and software. The drag determination component 530 uses various inputs to determine drag on the vehicle, taking into account data associated with an environmental condition. For example, the drag determination component 530 can use the following inputs to determine drag on the vehicle:

1. Acceleration (from AV compute and feedback of actual vehicle acceleration);

2. Target Speed (from AV compute and feedback of actual vehicle acceleration);

3. Road Wheel Angle (from AV compute and feedback of actual vehicle acceleration);

4. Drag coefficient of atmosphere (CdA) (from the sensor or AV compute);

5. Air Density (from the sensor or AV compute); and

6. Reference Area (OEM constant).

The air density and drag coefficient of the local atmosphere can be considered data associated with an environmental condition in accordance with embodiments of the present disclosure.

The velocity determination component 534 can use the calculated drag on the vehicle to refine the target velocity and target acceleration. The following algorithm provides one example:

In an embodiment, the optimization algorithm calculates various drag values of drag, Dₘᵢₙ, by optimizing the velocity of the vehicle V:

Dₘᵢₙ=C_{d}*A*0.5*ρ*V\hat{ }2, and [1]

D_{actual}[i]=(C_{d}C_{d}A)*A*0.5*ρ*V\hat{ }2[i] for i=1,2,3 . . . N, where N>1. [2]

### Where:

A=Reference surface area of the vehicle;
ρ=Air density;
C_{d}=Drag coefficient of the vehicle;
C_{d}A=Drag coefficient of the atmosphere; and
D=Drag force.
Each of the N D_{actual}[i] values of drag are compared to Dₘᵢₙ. If D_{actual}[i]=Dₘᵢₙ±Δ, where Δ is a matching tolerance (e.g., 5%) that can be calibrated based on a tradeoff of saving energy or getting to a destination faster. The D_{actual}[i] value that is the closest match to Dₘᵢₙ±Δ (referred to as Dₒₚₜ[i]), can be solved for target velocity, V_{target}, by replacing with V_{target} and replacing D_{actual}[i] with Dₒₚₜ[i] in Equation[2], the remaining variables all being known. V_{target} represents the maximum velocity the vehicle to ensure minimum drag on the vehicle. If V_{target} is increased, the drag on the vehicle due to atmospheric conditions will also increase, and the energy efficiency of the vehicle will be reduced. If V_{target} is decreased, the drag on the vehicle will decrease and the energy efficiency of the vehicle will increase. In an embodiment, a passenger in the vehicle can select a preference for speed and efficiency that can be used to set Δ. In an embodiment, a mean or median value of D_{actual}[i] can be computed and used to set V_{target} using Equation [2]. In an embodiment, the operating environment of the vehicle is used to set a default V_{target} value rather than computing an optimum value. This could occur, e.g., in a dense urban environment where the vehicle drag computation may be less accurate due to the vehicle constantly stopping and starting in traffic and the impact on airflow from other vehicles (e.g., drafting) or infrastructure.

In an embodiment, Cd can be based on the shape of the body of the vehicle. For example, Cd can be between 0.25 and 0.3 for most passenger vehicles and between 0.35 to 0.45 for “boxy” vehicles, such as SUVs.

In an embodiment, the minimum speed of the vehicle, Vₘᵢₙ, can be the legal speed limit ±α, where a is a tolerance value (e.g., α=5 mph). In some embodiments, Vₘᵢₙ can be set to the minimum speed limit if known.

Accordingly, after computing the target vehicle velocity, V_{target}, it can be compared to the speed limit ±α, and if above or below, it can be set to the legal speed limit if known.

In embodiments, the optimization component 404 includes an efficiency calculation component 536. Efficiency calculation component 536 determines vehicle efficiency characteristics using data associated with an environmental condition and other data (e.g., map data) to optimize vehicle efficiency. In embodiments, the efficiency calculation component 536 determines whether a vehicle can reach a destination under current atmospheric conditions based on remaining energy levels. Based on the energy remaining, the planning system 404 can replan a route to include a recharge or refueling of the vehicle to ensure the vehicle can refuel/recharge. Efficiency testing can be done by comparing a vehicle without atmospheric sensor(s) installed and with the atmospheric sensor(s) installed, and monitor the Watt hours/mile or mile/kilowatt hours or any other unit of efficiency. This comparison can prove that the atmospheric sensor is effective in achieving the desired the mileage efficiency.

FIG. 5C illustrates an example of how data associated with an environmental condition can be coupled to location information 538 for planning a path. The atmospheric conditions at various locations from the departure point to the destination can be provided to the planning system 404. Assuming multiple potential routes for the path, the data associated with an environmental condition can help inform the planning system 404 of which route is optimal. For example, a route that avoids strong headwinds can be desirable if the route increases vehicle efficiency, even if the route takes slightly more time than an alternative route (e.g., the fastest route based on traffic, accidents, etc.). By precalculating potential drag on the vehicle using predicted data associated with an environmental condition, the vehicle can plan a path that optimizes performance and efficiency.

FIG. 5D illustrates a vehicle calculating control information for controlling a vehicle in accordance with embodiments of the present disclosure. The AV compute 504 can include a control system 408. Control system 408 uses planning information from planning system 404 to generate control signals for the vehicle 509. The control signals are sent 541 to the drive-by-wire system 540, which controls acceleration/deceleration, braking and steering of the vehicle based on the control signals

### 5. Example Use Case—Airflow and Direction

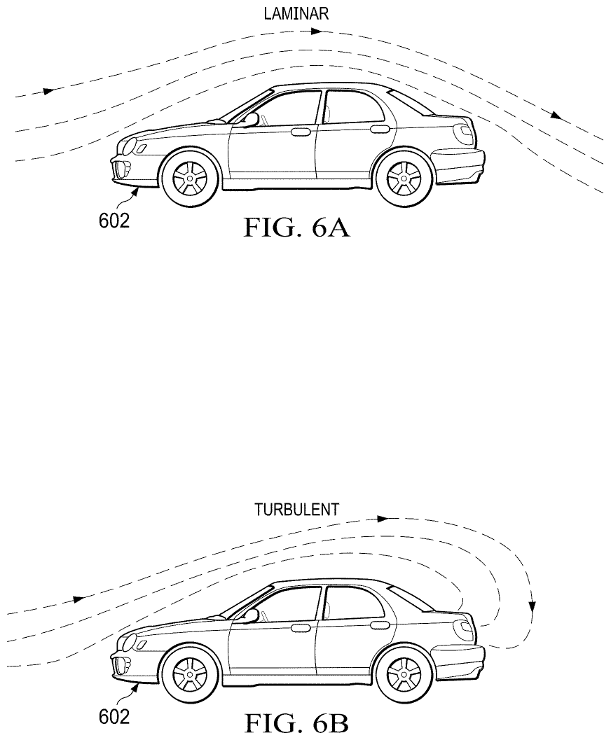

FIGS. 6A-6B are schematic diagrams illustrating a vehicle experiencing laminar and turbulent flow, respectively. Drag around the vehicle 602 (opposing force) is less when air flow is laminar (in the direction the vehicle 602 is traveling) and high when the flow is turbulent that can cause mileage efficiency issues. In an embodiment, sensors (e.g., an aerometer) can be used to measure wind speed, drag, aerodynamic coefficient and provide data about external disturbances. The data can be used to assess the intensity of the wind disturbance, atmospheric conditions to help mitigate vehicle performance issues.

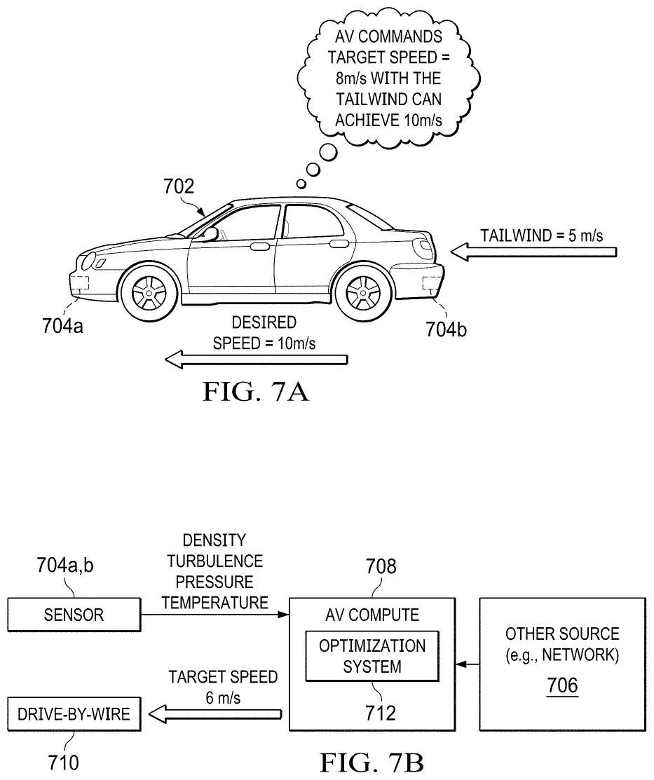

FIGS. 7A-7B are schematic diagrams illustrating example vehicle performance parameter calculations based on wind speed and direction information in accordance with embodiments of the present disclosure. A vehicle 702 includes sensors 704a and 704b. In this example, the vehicle 702 has a target velocity of 10 meters per second (m/s). The sensor 704b can detect a tailwind of 5 m/s. Other data associated with an environmental condition can be provided by other sources 706. The optimization system 712 in the AV compute 708 can be used to determine that the tailwind can assist the vehicle to achieve the target velocity. The optimization system 712 instructs the planning system 404 to set a velocity of 8 m/s based on the tailwind to achieve the target velocity. The planning system 404 in the AV compute 708 then instructs the drive-by-wire 710 to control the vehicle acceleration/deceleration, braking and steering accordingly.

### 6. Using Data Associated with Atmospheric Condition to Control a Vehicle

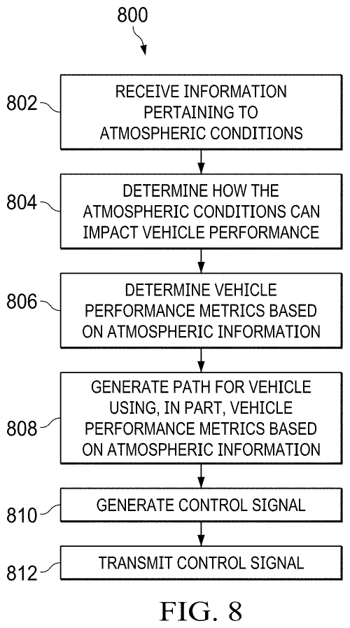

Referring now to FIG. 8, a flowchart of a process 800 is illustrated for controlling vehicle performance using data associated with an environmental condition in accordance with embodiments of the present disclosure. In an embodiment, one or more of the steps described with respect to process 800 are performed (e.g., completely, partially, and/or the like) by autonomous system 202. Additionally, or alternatively, in an embodiment one or more steps described with respect to process 800 are performed (e.g., completely, partially, and/or the like) by another device or group of devices separate from or including autonomous system 202 such as optimizer 530, AV compute 504, planning system 404, control system 408, and others, as described above.

At the outset, a vehicle can receive data pertaining to atmospheric conditions (802). The vehicle can receive data pertaining to atmospheric conditions from on-board sensors, other vehicles, networked sources, or other sources. The data can be stored in a local database or other repository. The vehicle can determine how the atmospheric conditions can impact vehicle performance (804). For example, the vehicle can determine how to optimize velocity and/or acceleration using measured or determined drag on the vehicle, where the drag is caused at least in part by atmospheric conditions outside the vehicle. The vehicle can determine vehicle performance metrics using the data associated with an environmental condition (806). Performance metrics can include but are not limited to: velocity of the vehicle, optimal route, and optimal efficiency. The vehicle can determine a path from a departure location to a destination location, taking into account the vehicle performance metrics, path optimization, and efficiency (808). The vehicle can generate a control signal (810) and transmit the control signal to a controller (e.g., drive-by-wire system) to implement the path (812).

In an embodiment, a method for controlling a vehicle includes: receiving (e.g., received from a vehicle-mounted sensor and/or downloaded into and received from AV stack), by a planning system using at least one processor, atmospheric information for the vehicle (e.g., air density, wind speed/direction, turbulence, barometric pressure, temperature, other conditions); determining, using the planning system, a vehicle performance metric using the atmospheric information (e.g., velocity of the vehicle, acceleration, power consumption); determining, using the planning system, a path using the vehicle performance metric (e.g., the information that the control circuit uses to control the vehicle); and providing, using the planning system, data associated with the path, wherein the data associated with the path is configured to cause the vehicle to operate based on the path.

In an embodiment, a system includes at least one processor, and at least one non-transitory storage media storing instructions that, when executed by the at least one processor, cause the at least one processor to identify data associated with an environmental condition for the vehicle; determine an vehicle performance metric using the data associated with an environmental condition; and control the vehicle using the determined vehicle performance metric.

In an embodiment, at least one non-transitory storage media storing instructions that, when executed by at least one processor, cause the at least one processor to identify data associated with an environmental condition for the vehicle; determine an vehicle performance metric using the data associated with an environmental condition; and control the vehicle using the determined vehicle performance metric.

In an implementation of the embodiments, determining the vehicle performance metric includes determining a drag value on the vehicle using the data associated with an environmental condition for a range of vehicle velocities.

In an implementation of the embodiments, determining the vehicle performance metric comprises determining a maximum velocity for the vehicle to achieve a lowest drag value.

In an implementation of the embodiments, the range of vehicle velocities is determined from a maximum and minimum legal speed on a road, a determined maximum and minimum safe speed for the road, or a maximum and minimum speed for the vehicle's remaining power level, or a predetermined maximum and minimum speed.

In an implementation of the embodiments, determining the drag comprises calculating the drag using data associated with an environmental condition and information about a surface area of the vehicle that is subjected to wind resistance. (e.g., drag is directly proportional to surface area).

In an implementation of the embodiments, the data associated with an environmental condition comprises air density surrounding the vehicle. (e.g., drag is directly proportional to air density).

In an implementation of the embodiments, the data associated with an environmental condition comprises at least one of air temperature, air turbulence, air pressure, air speed, or air direction.

In an implementation of the embodiments, determining the drag comprises calculating a result of Equation [2] above.

An implementation of the embodiments can include receiving, at the planning system, destination information that indicates a target destination for the vehicle (e.g., the vehicle can have a route that can include several different atmospheric conditions. These atmospheric conditions can be used in route planning, such that wind speed/direction that reduces efficiency can be avoided); determining, using the planning system, a plurality of routes for the vehicle to arrive at the destination (e.g., there may be multiple options for routes the vehicle can take); identifying, using the planning system, data associated with an environmental condition for each of the plurality of routes (e.g., wind speed/direction, air density, pressure, etc. can be different in different parts of a state/country, and along different routes, and at different times of the day. Maybe head west first before heading south, etc.); calculating, using the planning system, vehicle performance for the vehicle to traverse each route based on the data associated with an environmental condition (e.g., for each route and for each route's or location's data associated with an environmental condition, figure out how that will impact vehicle performance); and planning, using the planning system, an optimized route for the vehicle based on the data associated with an environmental condition and the vehicle performance. (e.g., pick a route that maximizes efficiency based on the atmospheric information).

In an implementation of the embodiments, vehicle performance is based on drag on the vehicle, and the drag is determined using the data associated with an environmental condition.

An implementation of the embodiments also includes sending, to a control system, the vehicle trajectory information; and controlling, by the control system using at least one processor, the vehicle using the determined vehicle trajectory information.

In the foregoing description, aspects and embodiments of the present disclosure have been described with reference to numerous specific details that can vary from implementation to implementation. Accordingly, the description and drawings are to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction. Any definitions expressly set forth herein for terms contained in such claims shall govern the meaning of such terms as used in the claims. In addition, when we use the term “further comprising,” in the foregoing description or following claims, what follows this phrase can be an additional step or entity, or a sub-step/sub-entity of a previously-recited step or entity.

1. A method for controlling a vehicle comprising:
receiving, using at least one processor, data associated with an environmental condition for the vehicle;
determining, using the at least one processor, a vehicle performance metric using the data associated with the environmental condition;
determining, using the at least one processor, a path using the vehicle performance metric; and
providing, using the at least one processor, data associated with the path, wherein the data associated with the path is configured to cause the vehicle to operate based on the path.

2. The method of claim 1, wherein determining the vehicle performance metric comprises determining a drag value on the vehicle using the data associated with an environmental condition for a range of vehicle velocities.

3. The method of claim 2, wherein determining the drag value comprises calculating the drag value using the data associated with the environmental condition and information about a surface area of the vehicle.

4. The method of claim 2, wherein determining the drag comprises calculating a result of D=Cd*A*0.5*ρ*V\hat{ }2,
where D is drag, Cd is a coefficient of drag, A is a reference surface area of the vehicle, p is air density, and V is velocity of the vehicle.

5. The method of claim 1, wherein determining the vehicle performance metric comprises determining a maximum velocity for the vehicle to achieve a lowest drag value.

6. The method of claim 1, wherein the range of vehicle velocities is determined from a maximum and minimum legal speed on a road, a determined maximum and minimum safe speed for the road, a maximum and minimum speed for the vehicle's remaining power level, or a predetermined maximum and minimum speed.

7. The method of claim 1, wherein the data associated with the environmental condition comprises data associated with air density surrounding the vehicle.

8. The method of claim 1, wherein the data associated with the environmental condition comprises data associated with at least one of air temperature, air turbulence, air pressure, air speed, or air direction.

9. The method of claim 1, further comprising:
receiving, at the vehicle, destination information that indicates a target destination for the vehicle;
determining, using the planning system, a plurality of routes for the vehicle to arrive at the destination;
identifying, using the at least one processor, the data associated with the environmental condition for each of the plurality of routes;
calculating, using the at least one processor, vehicle performance for the vehicle to traverse each route based on the data associated with the environmental condition;
planning, using the at least one processor, an optimized route for the vehicle based on the data associated with the environmental condition and the vehicle performance.

10. The method of claim 9, wherein vehicle performance is based on drag on the vehicle, and the drag is determined using the data associated with the environmental condition.

11. The method of claim 1, further comprising controlling, by a control system using at least one processor, the vehicle using the determined vehicle trajectory information.

12. A system, comprising:
at least one processor, and
at least one non-transitory storage media storing instructions that, when executed by the at least one processor, cause the at least one processor to:
identify data associated with an environmental condition for the vehicle;
determine an vehicle performance metric using the data associated with the environmental condition; and
control the vehicle using the determined vehicle performance metric.

13. The system of claim 12, wherein the instructions cause the at least one processor to determine a drag value on the vehicle using the data associated with the environmental condition for a range of potential velocities.

14. The system of claim 13, wherein the instructions cause the at least one processor to determine a maximum velocity for the vehicle based on one of the determined drag values.

15. The system of claim 13, wherein the instructions cause the at least one processor to determine a target velocity for the vehicle to minimize drag on the vehicle.

16. The system of claim 13, wherein the instructions cause the at least one processor to calculate a result of D=Cd*A*0.5*ρ*v\hat{ }2, where D is drag, Cd is a constant, A is a reference area of the vehicle, p is air density, and v is a velocity of the vehicle.

17. A vehicle comprising:
a planning system comprising at least one processor to:
determine a vehicle performance metric using data associated with an environmental condition, and
generate vehicle control commands using the vehicle performance metric; and
a control system comprising at least one processor to:
receive the vehicle control commands from the planning system, and
control the vehicle using the vehicle control commands.

18. The vehicle of claim 17, further comprising at least one atmospheric sensor to sense the environmental condition at the vehicle.

19. The vehicle of claim 17, further comprising:
a receiver to receive the data associated with the environmental condition; and
a database to store the data associated with the environmental condition;
the planning system to determine vehicle performance metric using the data associated with the environmental condition stored in the database.

20. The vehicle of claim 17, the planning system to:
determine a route for the vehicle using the data associated with the environmental condition; and
generate control commands for the vehicle to traverse the route.
